(19) United States
(12) Patent Application Publication
(10) Pub. No.: US 2025/0291784 A1
(43) Pub. Date: Sep. 18, 2025

(54) Data Processing System

(71) Applicants: Inventec (Pudong) Technology Corp., Shanghai (CN); Inventec Corporation, Taipei (TW)

(72) Inventors: Wei-Chao Chen, Taipei (TW); Ming-Chi Chang, Taipei (TW); Chuo-Jui Wu, Taipei (TW)

(73) Assignees: Inventec (Pudong) Technology Corp., Shanghai (CN); Inventec Corporation, Taipei (TW)

(21) Appl. No.: 18/658,965

(22) Filed: May 8, 2024

(30) Foreign Application Priority Data
Mar. 14, 2024 (CN) 202410295104.3

(51) Int. Cl. G06F 16/22; G06F 16/2455

(52) U.S. Cl. CPC G06F 16/2282; G06F 16/24553

(57) ABSTRACT

A data processing system for processing an uploaded data comprising a data name and a data content is provided. The data processing system performs querying an expanded database table in a database according to the data name to obtain a first data based on a first sequence number; comparing column data types of the data content with the first data to obtain a comparison result; when the column data types of the data content are consistent with the first data, obtaining a first table corresponding to the first data; otherwise, creating the first table according to the column data types of the data content and a second sequence number, and storing a second data corresponding to the first table and the second sequence number in the expanded database table; storing the data content in the first table; and merging tables according to the data name.

### BACKGROUND OF THE INVENTION

### 1. Field of the Invention

The present invention relates to a data processing system, and more particularly, to a data processing system capable of automatically adjusting the table structure according to the data content.

### 2. Description of the Prior Art

With the digitization of information and the development of digital applications, digital transformation is imperative, and there is a need for access to databases in various fields. In order to satisfy the diversification of data applications, the types of databases are also booming. Among them, relational databases such as Oracle, MySQL, SQL Server are still the mainstream in the industry. The relational database usually stores data through multiple tables with predefined and strictly structured relationships between the table and data therein.

In the prior art, before storing data in the database, users often need to confirm the requirements with the database technicians, and the database technicians thereby define data schema for tables so as to build a table that meets the users' needs, including the fields, data types, and relationship. After the tables are set up and a certain amount of data is stored, once subsequent changes in the table structure are required, database technicians must still be relied upon to adjust the table structure. However, with the development of digital applications, it is often impossible for data providers to predict the final content and the type of data to be stored, and when the frequency of data changes increases, database technicians will face considerable labor burdens and the cost of database changes. This problem is particularly acute when using associative databases.

In this situation, the database technicians usually respond to changes in data structure by resetting the table or adding a new table. However, the method of resetting the table is not suitable for situations where the amount of data in the table is huge, and the method of adding a new table may cause the data structure to become complicated and need to modify stored programs accordingly, resulting in increased maintenance costs. Therefore, there is an urgent need to have a method for automatically adjusting existing table, which automatically adjusts the structure of the table according to the data content uploaded by users to save manpower and reduce costs.

### SUMMARY OF THE INVENTION

Therefore, the present invention aims to provide a data processing system capable of determining the data content so as to automatically adjust the fields of the table, thereby improving the shortcomings of the conventional technology.

An embodiment of the present invention discloses a data processing system. The data processing system is coupled to a database and used for processing an uploaded data, wherein the uploaded data comprises a data content and a data name. The data processing system comprises a processing unit and a storage unit. The processing unit is configured to execute a program code. The storage unit is coupled to the processing unit and configured to store the program code to instruct the processing unit to execute a data processing method. The data processing method comprises querying an expanded database table in the database according to the data name to obtain a first data based on a first sequence number; comparing column data types of the data content of the uploaded data with the first data to obtain a comparison result; in response to the comparison result indicating that the column data types of the data content are consistent with the first data, obtaining a first table corresponding to the first data; in response to the comparison result indicating that the column data types of the data content are not consistent with the first data, creating the first table according to the column data types of the data content and a second sequence number, and storing a second data corresponding to the first table and the second sequence number in the expanded database table; storing the data content in the first table; and merging tables according to the data name.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a data processing system for processing an uploaded data according to an embodiment of the present invention.

FIG. 2 is a schematic diagram of a data processing process according to an embodiment of the present invention.

FIG. 3 is a schematic diagram of a table merging process according to an embodiment of the present invention.

FIG. 4 is a schematic diagram of a data processing system according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”.

Please refer to Table 1, which is a description of field properties of a table called “customer”. The field properties include the names of the fields and the data types corresponding to the fields. As shown in Table 1, the “customer” table initially contains only three fields: “lastName” (last names of customers), “gender” (genders of the customers), and “id” (identification number of the customers).

TABLE 1

| | | | | | |
|---|---|---|---|---|---|
| Field | Type | Null | Key | Default | Extra |

| | | | |
|---|---|---|---|
| lastName | varchar(4) | YES | NULL |
| gender | varchar(1) | YES | NULL |
| id | char(10) | YES | NULL |

According to the description of the field properties in Table 1, the “customer” table may be used to store customer data as shown in Table 2 below.

TABLE 2

| lastName | gender | id |
|---|---|---|
| Chen | M | A111111111 |
| An | F | B222222222 |

However, as the business needs change, users may need to store more information such as the ages of their customers. In this situation, the database technicians need to adjust the fields of the “customer” table as shown in Table 3 to meet the new requirements accordingly.

TABLE 3

| | | | | | |
|---|---|---|---|---|---|
| Field | Type | Null | Key | Default | Extra |

| | | | |
|---|---|---|---|
| lastName | varchar(4) | YES | NULL |
| gender | varchar(1) | YES | NULL |
| id | char(10) | YES | NULL |
| age | float(3.1) | YES | NULL |

According to the description of the field properties of the adjusted “customer” table in Table 3, users may store customer data including customer ages. However, as business expands, users may further need to store information related to foreign customers (that have longer last name). In this situation, the data length of the “lastName” field in the “customer” table shown in Table 3 is insufficient, and the database technicians need to adjust the fields of the “customer” table again according to the new requirements, as shown in Table 4.

TABLE 4

| | | | | | |
|---|---|---|---|---|---|
| Field | Type | Null | Key | Default | Extra |

| | | | |
|---|---|---|---|
| lastName | varchar(10) | YES | NULL |
| gender | varchar(1) | YES | NULL |
| id | char(10) | YES | NULL |
| age | float(3.1) | YES | NULL |

Accordingly, the users may store the foreign customers' information in the adjusted “customer” table as shown in Table 5 below.

TABLE 5

| lastName | gender | id | age |
|---|---|---|---|
| Aniston | M | E299912343 | 55.0 |
| Geller | F | K199987654 | 66.0 |

Since changes in table fields (including adjusting data types of fields and adding new fields) usually occur when the table has already stored data, the database technicians usually need to export the existing data, rebuild a new “customer” table, complete data in missing field, and re-import data, etc. so as to carry out the table field adjustments mentioned above.

Furthermore, when the table has already stored a huge amount of data, database technicians may respond to changes in table fields by adding a new table. For example, when adding a new field “age” in the “customer” table as mentioned above, the database technicians may additionally create a “CustomerAge” table for storing customers' age data as shown by the description of the field properties of the “CustomerAge” table in Table 6 below, and then use the “id” field as a related column (as key) between the new “CustomerAge” table and the original “customer” table to combine (join) relevant data row therebetween. However, this method may not only increase the complexity of the relations between the tables, but also require modifications of the related stored procedure, resulting in the risk of destroying the integrity of the data structure.

TABLE 6

| | | | | | |
|---|---|---|---|---|---|
| Field | Type | Null | Key | Default | Extra |

| | | | |
|---|---|---|---|
| id | char(10) | YES | NULL |
| age | float(3.1) | YES | NULL |

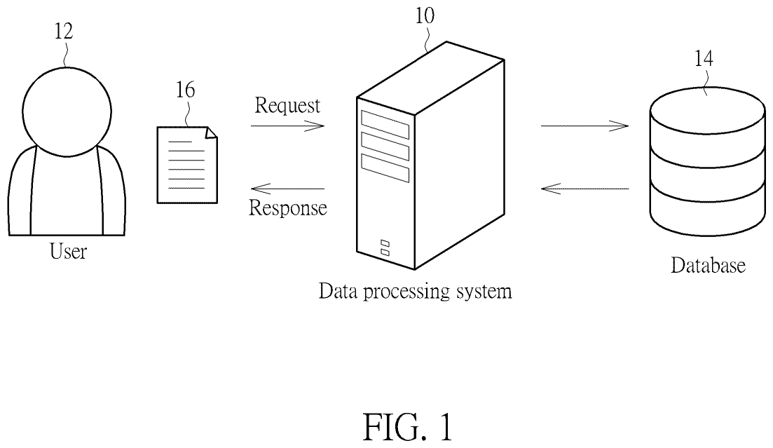

Therefore, the embodiment of the present invention provides a data processing system that may analyze the structure of data uploaded by users and automatically adjust the table fields and the data types of the fields accordingly. Please refer to FIG. 1, which is a schematic diagram of a data processing system 10 for processing an uploaded data according to an embodiment of the present invention. As shown in FIG. 1, a user 12 may access a database 14 through the data processing system 10 and send an uploaded data 16 to the data processing system 10 for processing. In the embodiment of the present invention, the database 14 may be any relational database such as Oracle, MySQL, SQL Server, and is not limited thereto. The uploaded data 16 comprises a data name and a data content, where the data name is a name of the table to be accessed in the database 14, and the data content is a structured data. It should be noted, in the embodiment of the present invention, the data processing system 10 needs to have the authority to access the database 14, including the authorities to create and delete (drop) tables.

In the embodiment of the present invention, the data processing system 10 needs to create an expanded database table in advance, in which the description of the field properties of the expanded database table may be as shown in Table 7. The expanded database table at least comprises a “table name” field for a column of table names, a “column name” field for a column of field names, a “type” field for a column of data types corresponding to the fields and a “seq” field for a column of the sequence numbers. It should be noted, Table 7 merely shows the necessary fields required to realize the embodiments of the present invention, in which the field names, the number of the fields, data types corresponding to the fields (called column data type hereinafter), etc. of the expanded database table should be adjusted according to actual needs and are not limited thereto.

TABLE 7

| | | | | | |
|---|---|---|---|---|---|
| Field | Type | Null | Key | Default | Extra |

| | | | |
|---|---|---|---|
| table name | char(20) | NO | NULL |
| column name | char(20) | NO | NULL |
| type | char(20) | NO | NULL |
| seq | int(11) | NO | NULL |

In the embodiment of the present invention, the data processing system 10 may obtain information including the table name of each table, all field names in each table, and the data type of each field from the database 14, and store the information in the expanded database table according to the description of the field properties of the expanded database table shown in Table 7. Taking the “customer” table in Table 1 as an example, the data processing system 10 may store the data in the extended database table as shown in Table 8, and use 0 as the starting sequence number value. According to the expanded database table, the data processing system 10 is able to obtain the table names of all tables, all field names, data types corresponding to the fields (column data types) and sequence numbers in the database 14, and thereby determine if the fields of the table needs to be adjusted on the basis of the uploaded data 16.

TABLE 8

| table_name | column_name | type | seq |
|---|---|---|---|
| customer | lastName | varchar(4) | 0 |
| customer | gender | varchar(1) | 0 |
| customer | id | char(10) | 0 |

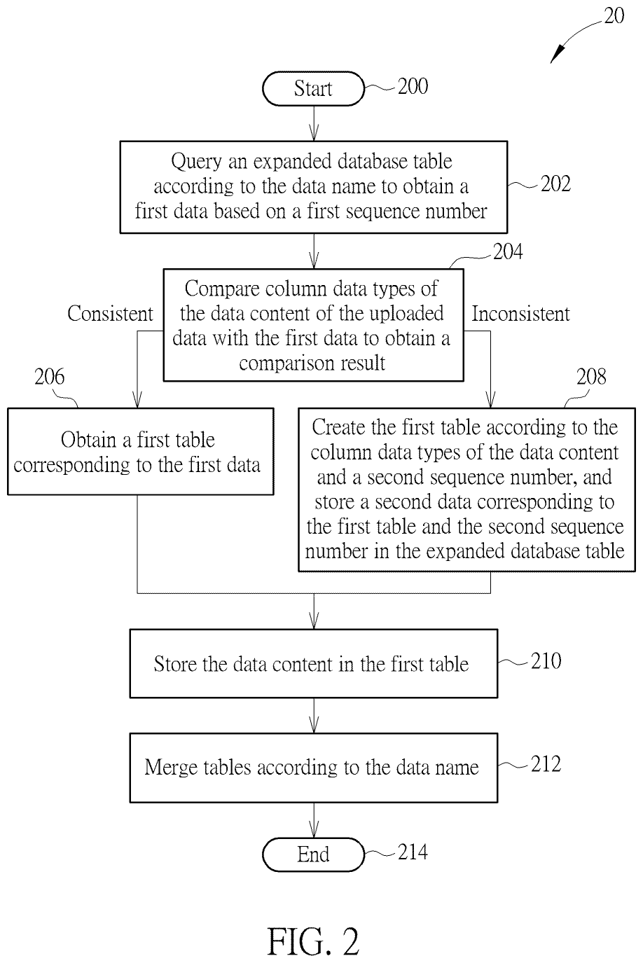

As mentioned above, the embodiment of the present invention may be used for processing the uploaded data 16, and automatically adjust the fields of the related table in the database 14 (including adjusting data types of fields and increasing new fields) according to the uploaded data 16. As shown in FIG. 2, the data processing method of the embodiment of the present invention may be summarized into a data processing process 20. The data processing process 20 comprises the following steps:

Step 200: Start.

Step 202: Query an expanded database table according to the data name to obtain a first data based on a first sequence number.

Step 204: Compare column data types of the data content of the uploaded data with the first data to obtain a comparison result. If the comparison result indicates that the column data types of the data content are consistent with the first data, proceed to Step 206; otherwise, proceed to Step 208.

Step 206: Obtain a first table corresponding to the first data.

Step 208: Create the first table according to the column data types of the data content and a second sequence number, and store a second data corresponding to the first table and the second sequence number in the expanded database table.

Step 210: Store the data content in the first table.

Step 212: Merge tables according to the data name.

Step 214: End.

According to the data processing process 20, after receiving the uploaded data 16 sent by the user 12, the data processing system 10 first queries the expanded database table according to the data name of the uploaded data 16 and selects a first data with a largest sequence number among the data whose table name matches the data name (Step 202). The first data may comprises a table name, a first sequence number (for example, N), at least one field name and the corresponding column data type. Then, the data processing system 10 compares the column data types of the data content of the uploaded data 16 with the first data to obtain a comparison result (Step 204). If the comparison result indicates that the column data types of the data content are consistent with the first data, the data processing system 10 may determine the table corresponding to the table name of the first data to be a first table (Step 206). If the comparison result indicates that the column data types of the data content are not consistent with the first data, the data processing system 10 may create a first table according to the column data types of the data content of the uploaded data 16 and a second sequence number, and store the information about the second sequence number, the table name, each field name and column data types of the first table to the extended database table (Step 208). The second sequence number may be obtained incrementally according to the first sequence number (for example, N+1). Finally, the data processing system 10 may store the data content of the uploaded data 16 in the first table (Step 210) and merge tables based on the data name at an appropriate time. Accordingly, the users are able to instantly upload data content with new or modified fields without waiting for database technicians to manually adjust tables or complete data integration before uploading data.

Specifically, in Step 202, the data processing system 10 queries the expanded database table according to the data name to obtain a first data based on a first sequence number. When querying the expanded database table, the data processing system 10 queries the data with the same prefix as the data name of the uploaded data 16 in the table name field (“table name”), and selects the data with the largest value in the corresponding sequence number field (“seq”) as the first sequence number, and the data corresponding to the first sequence number as the first data. The first data describes the most recent table among the tables corresponding to the data name, and the most recent table has the largest number of fields or has the maximum data length (e.g., string length) among corresponding fields.

In Step 204, the data processing system 10 compares the column data types of the data content of the uploaded data 16 with the first data to obtain a comparison result. In this step, the data processing system 10 checks the column data types of the data content of the uploaded data 16 one by one to determine whether the data content of the uploaded data 16 is compatible with the table corresponding to the first data. When the comparison result indicates that the column data types of the data content are consistent with the first data, it means that the data content of the uploaded data 16 may be directly stored in the table corresponding to the first data. Therefore, the data processing system 10 determines that the table corresponding to the first data is the first table in Step 206. When the comparison result indicates that the column data types of the data content are not consistent with the first data, it means that the data content of the uploaded data 16 may include a new field or an existing field with a column data type change. In this situation, the data processing system 10 has to create an expanded table to store the data content of the uploaded data 16, and therefore, the data processing system 10 may create the first table for storing the data content of the uploaded data 16 according to the column data types thereof in Step 208.

Specifically, in Step 208, the data processing system 10 obtains the second sequence number based on the first sequence number, and the second sequence number may be incremented (for example, by 1) based on the first sequence number. Accordingly, the data processing system 10 uses the data name of the uploaded data 16 as a prefix and the second sequence number as a suffix to determine the table name of the first table. Taking the “customer” table in Table 8 as an example, when the fields of the data content of the uploaded data 16 do not match the first data (for example, a field for customer ages is added), the data processing system 10 may obtain the second sequence number of 1 according to Step 208 and create the first table with the name of “customer_expand_1” accordingly. Then, the data processing system 10 stores a second data corresponding to the first table and the second sequence number in the extended database table, as shown in Table 9 below.

TABLE 9

| table_name | column_name | type | seq |
|---|---|---|---|
| customer_expand_1 | lastName | varchar(4) | 1 |
| customer_expand_1 | gender | varchar(1) | 1 |
| customer_expand_1 | id | char(10) | 1 |
| customer_expand_1 | age | float(3.1) | 1 |

Next, in Step 210, the data processing system 10 stores the data content of the uploaded data 16 in the first table determined in Steps 204-208. Accordingly, the user 12 is able to store the uploaded data 16 without changing the existing data in the database 14.

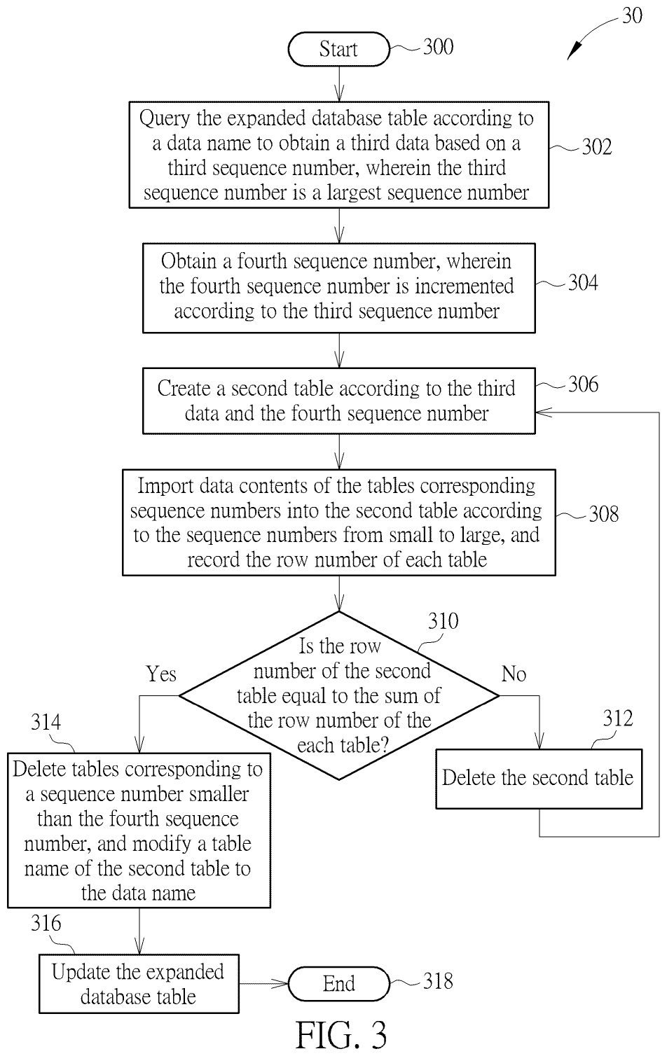

Finally, in Step 212, the data processing system 10 may merge tables based on data names at an appropriate time. In other words, the data processing system 10 merges all the expanded tables created in step 208. The appropriate time comprises merging the tables when the data processing system 10 receives a request such as “GET”, “UPDATE”, or “DELETE” from a user to access the data of a table relating to the data name, or merging the tables based on a predetermined time, or merging the tables periodicity (e.g., in non-business days). The method for merging the tables may be summarized into a table merging process 30 as shown in FIG. 3. The table merging process 30 comprises the following steps:

Step 300: Start.

Step 302: Query the expanded database table according to a data name to obtain a third data based on a third sequence number, wherein the third sequence number is a largest sequence number.

Step 304: Obtain a fourth sequence number, wherein the fourth sequence number is incremented according to the third sequence number.

Step 306: Create a second table according to the third data and the fourth sequence number.

Step 308: Import data contents of the tables corresponding sequence numbers into the second table according to the sequence numbers from small to large, and record the row number of each table.

Step 310: Determine whether the row number of the second table is equal to the sum of the row number of the each table. If yes, proceed to Step 314; otherwise, proceed to Step 312.

Step 312: Delete the second table, and proceed to Step 306.

Step 314: Delete tables corresponding to a sequence number smaller than the fourth sequence number, and modify a table name of the second table to the data name.

Step 316: Update the expanded database table.

Step 318: End.

According to the table merging process 30, the data processing system 10 merges the previously established expanded tables.

In detail, in Step 302, the data processing system 10 queries the extended database table according to a designated data name, and then obtains a third sequence number (the largest sequence number) and a third data corresponding to the third sequence number among data where the data name is consistent with the table name. In the embodiment, the data name being consistent with the table name means that a prefix of a table name stored in the table name field (“table name”) of the expanded database table is the same as the designated data name. That is to say, based on the data name, the data processing system 10 may query the original table whose table name is exactly the same as the data name and all the expanded tables created in Step 208, and select the data with the largest sequence number as the third data therein. The third data comprises the table name, the third sequence number, at least one field name and the corresponding column data type of the most recent extended table.

In Step 304 to Step 306, the data processing system 10 obtains a fourth sequence number based on the third sequence number, and creates a second table for merging according to the third data and the fourth sequence number. The fourth sequence number is incremented based on the third sequence number; that is, the value of the third sequence number plus 1 is used as the fourth sequence number. The data processing system 10 uses the data name as the prefix and the fourth sequence number as the suffix to determine the table name of the second table, and creates the second table according to the information recorded in the third data.

In Step 308, the data processing system 10 sequentially imports the data contents of the table corresponding to the sequence number into the second table according to the sequence number from small to large, and records the row number in each table. In the embodiment, the data processing system 10 imports the data sequentially according to the order of the sequence number from small to large, which avoids the intermingling of new and old data from affecting the efficiency of subsequent data access. The row number of the each imported table is recorded to ensure that all data is completely imported into the second table. In Steps 310 to 312, the data processing system 10 checks whether the row number in the second table is equal to the sum of the row number of each imported table. If the row numbers does not match, the data processing system 10 may delete the second table and proceed to Step 306 again.

After the data is successfully imported in Step 308, the data processing system 10 deletes the tables with corresponding sequence number smaller than the fourth sequence number in Step 314, and modifies the table name of the second table to the data name. In other words, the data processing system 10 first deletes all tables that have successfully imported data into the second table, and then modifies the table name of the second table to the data name.

Finally, in Step 316, the data processing system 10 updates the expanded database table. Specifically, the data processing system 10 first deletes the data that matches the data name with the prefix of the table name and whose corresponding sequence number is smaller than the third sequence number in the expanded database table, and then modifies the data that corresponds to the third sequence number by modifying the table name to the data name and by modifying the value of the sequence number field to 0.

Accordingly, the data processing system 10 is capable of merging data distributed in several tables. Taking the “customer” table mentioned above as an example, after the “age” field is added and the column data type of the “lastName” field is modified according to the data processing process 20, the expanded database table records the data as shown in Table 10.

TABLE 10

| table_name | column_name | type | seq |
|---|---|---|---|
| customer | lastName | varchar(4) | 0 |
| customer | gender | varchar(1) | 0 |
| customer | id | char(10) | 0 |
| customer_expand_1 | lastName | varchar(4) | 1 |
| customer_expand_1 | gender | varchar(1) | 1 |
| customer_expand_1 | id | char(10) | 1 |
| customer_expand_1 | age | float(3.1) | 1 |
| customer_expand_2 | lastName | varchar(10) | 2 |
| customer_expand_2 | gender | varchar(1) | 2 |
| customer_expand_2 | id | char(10) | 2 |
| customer_expand_2 | age | float(3.1) | 2 |

In Table 10, the rows with a sequence number of 0 in the “seq” field correspond to the original “customer” table, which includes the “lastName” field with column data type “varchar (4)”, the “gender” field with column data type “varchar (1)”, and the “id” field with column data type “char (10)”. The rows with a sequence number of 1 in the “seq” field correspond to the expanded “customer_expand_1” table with the newly added “age” field, which includes the “lastName” field with column data type “varchar (4)”, the “gender” field with column data type “varchar (1)”, the “id” field with column data type “char (10)” and the “age” field with column data type “float (3,1)”. The rows with a sequence number of 2 in the “seq” field correspond to the expanded “customer_expand_2” table with the newly adjusted “lastName” field, which includes the “lastName” field with column data type “varchar (10)”, the “gender” field with column data type “varchar (1)”, the “id” field with column data type “char (10)” and the “age” field with column data type “float (3,1)”. That is to say, the expanded database table records the table name of each table, each field name, the column data type corresponding to each field, and the sequence number used to distinguish between old and new tables.

The data processing system 10 may merge the tables “customer”, “customer_expand_1” and “customer_expand_2” into a new “customer” table at an appropriate time as described above. According to the table merging process 30, the data processing system 10 may specify the data name “customer” in Step 302 and query the expanded database table based on the specified data name. Accordingly, the data processing system 10 obtains the relevant 11 rows of data (related to 3 tables) as shown in Table 10 and the corresponding sequence numbers 0, 1, and 2. The data processing system 10 uses the largest sequence number “2” as the third sequence number, and uses the 4 rows of data corresponding to the sequence number “2” as the third data (the corresponding table name is “customer_expand_2”). Next, the data processing system 10 obtains the fourth sequence number “3” by incrementing according to the third sequence number “2” in Step 304, and creates a second table with the name of “customer_expand_3” in Step 306. In Step 308, the data processing system 10 sequentially imports the data contents of the tables “customer”, “customer_expand_1” and “customer_expand_2” into the second table according to the sequence number from small to large. After successfully importing data, the data processing system 10 first deletes the tables “customer”, “customer_expand_1” and “customer_expand_2” in Step 314, and then modifies the table name of the second table from “customer_expand_3” to “customer”. Finally, the data processing system 10 deletes the data corresponding to the tables “customer” and “customer_expand_1” in the expanded database table, and modifies the data corresponding to the third sequence number “2” as shown in Table 11 below. In Table 11, the table name (“table name”) corresponding to the “customer_expand_2” table is modified from “customer_expand_2” to “customer”, and the sequence number (“seq”) is reset to 0. Accordingly, the data processing system 10 merges the “customer” table, the “customer_expand_1” table and the “customer_expand_2” table into a new “customer” table.

TABLE 11

| table_name | column_name | type | seq |
|---|---|---|---|
| customer | lastName | varchar(10) | 0 |
| customer | gender | varchar(1) | 0 |
| customer | id | char(10) | 0 |
| customer | age | float(3.1) | 0 |

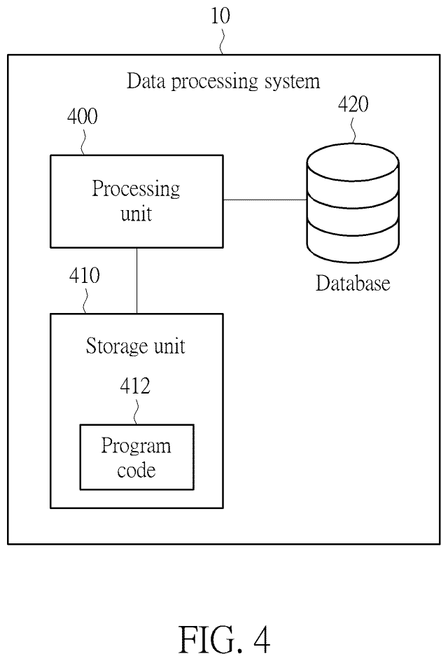

Furthermore, please refer to FIG. 4, which is a schematic diagram of the data processing system 10 according to an embodiment of the present invention. As shown in FIG. 4, the data processing system 10 may comprise a processing unit 400, a storage unit 410 and a database 420. The processing unit 400 may be a general-purpose processor, a microprocessor, an application specific integrated circuit (ASIC) or a combination thereof. The storage unit 410 may be any types of data storage device for storing a program code 412, and the program code 412 is read and executed by the processing unit 400. For example, the storage unit 410 may be a read-only memory (ROM), a flash memory, a random-access memory (RAM), a hard disk, an optical data storage device, a non-volatile storage unit, etc., and is not limited thereto. The database 420 may be used to realize the database 14, and may be any relational database, such as Oracle, MySQL, SQL Server, and is not limited thereto. It should be noted, the database 420 is illustrated in the data processing system 10; however, it is not limited thereto. As long as the data processing system 10 has the necessary authorities to access the database 420, the automatic expansion according to the embodiment of the present invention may be realizable.

The data processing system 10 is used to represent the necessary components required to implement the embodiments of the present invention, and those skilled in the art may make various modifications and adjustments accordingly, and is not limited to this. For example, the data processing process 20 and the table merging process 30 may be complied into the program code 412, stored in the storage unit 410, and executed by the processing unit 400. Moreover, the storage unit 410 is also used for storing the data required for running the data processing method and is not limited thereto.

In summary, the present invention provides a data processing method and system, which automatically adds fields to the table and adjusts the column data types of the table according to the data content of the uploaded data, improving the shortcomings of the conventional technology.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data processing system, coupled to a database, used for processing an uploaded data, wherein the uploaded data comprises
a data content and a data name, the data processing system comprising:
a processing unit, configured to execute a program code; and
a storage unit, coupled to the processing unit, configured to store the program code to instruct the processing unit to execute a data processing method, wherein the data processing method comprises:
querying an expanded database table in the database according to the data name to obtain a first data based on a first sequence number;
comparing column data types of the data content of the uploaded data with the first data to obtain a comparison result;
in response to the comparison result indicating that the column data types of the data content are consistent with the first data, obtaining a first table corresponding to the first data;
in response to the comparison result indicating that the column data types of the data content are not consistent with the first data, creating the first table according to the column data types of the data content and a second sequence number, and storing a second data corresponding to the first table and the second sequence number in the expanded database table;
storing the data content in the first table; and
merging tables according to the data name.

2. The data processing system of claim 1, wherein the database is a relational database, and the data content of the uploaded data is a structured data.

3. The data processing system of claim 1, wherein the expanded database table stores corresponding relations between a name of each table in the database, a name of each field, a data type corresponding to the each column, and a sequence number.

4. The data processing system of claim 1, wherein the step of querying the expanded database table in the database according to the data name to obtain the first data based on the first sequence number comprises:
selecting all data in the expanded database table with a prefix of a table name matching the data name; and
determining a data corresponding to a largest sequence number to be the first data, and the first sequence number to be the largest sequence number.

5. The data processing system of claim 4, wherein the second sequence number is incremented according to the first sequence number.

6. The data processing system of claim 1, wherein in the step of creating the first table according to the column data types of the data content and the second sequence number, a prefix of a table name of the first table is the data name, and a suffix of the table name is the second sequence number.

7. The data processing system of claim 1, wherein the step of merging tables according to the data name is executed in response to the data processing system receiving GET, PUT, or DELETE requests.

8. The data processing system of claim 1, wherein the step of merging tables according to the data name is executed in a predetermined time or executed periodically.

9. The data processing system of claim 1, wherein the step of merging tables according to the data name comprises:
querying the expanded database table according to the data name to obtain a third data based on a third sequence number, wherein the third sequence number is a largest sequence number;
obtaining a fourth sequence number, wherein the fourth sequence number is incremented according to the third sequence number;
creating a second table according to the third data and the fourth sequence number;
importing data contents of tables corresponding sequence numbers into the second table according to the sequence numbers from small to large;
deleting tables corresponding to a sequence number smaller than the fourth sequence number;
modifying a table name of the second table to the data name; and
updating the expanded database table.

10. The data processing system of claim 9, wherein the step of updating the expanded database table comprises:
deleting data with a table name with a prefix being consistent to the data name and a sequence number being smaller than the third sequence number; and
modifying a table name corresponding to the third sequence number to the data name, and modifying the third sequence number to 0.
